(19) United States
(12) Patent Application Publication
(10) Pub. No.: US 2023/0093513 A1
(43) Pub. Date: Mar. 23, 2023

(54) ADJUSTABLE SHIELD FOR LOCAL AUSTENITIZING

(71) Applicants: Bjoern MUELLER, Attendorn (DE); Patrick MUELLER, Kirchhundem (DE); Maik WINDERLICH, Drolshagen (DE); Thorsten WISNIA, Attendorn (DE)

(72) Inventors: Bjoern MUELLER, Attendorn (DE); Patrick MUELLER, Kirchhundem (DE); Maik WINDERLICH, Drolshagen (DE); Thorsten WISNIA, Attendorn (DE)

(21) Appl. No.: 17/948,805

(22) Filed: Sep. 20, 2022

(30) Foreign Application Priority Data
Sep. 22, 2021 (DE) 102021124531.1

(51) Int. Cl. C21D 9/00; C21D 9/46

(52) U.S. Cl. CPC C21D 9/0025; C21D 9/46; C21D 2211/001

(57) ABSTRACT

A shield covers a predetermined region of a plate workpiece during tempering of the plate workpiece in a furnace in which the shield and the workpiece are subjected to an austenitization temperature while the predetermined region of the plate is shielded by the shield against heat. The shield has at least one first shield part shaped to cover at least some of the predetermined region of the workpiece, at least one second shield part, and a fastener or the like securing the second part movably relative to or removable from the first part such that the first and second parts together achieve an optimum shape fully covering and shielding the predetermined region of the plate workpiece.

### FIELD OF THE INVENTION

The present invention relates to locally austenitizing a workpiece. More particularly this invention concerns a shield for use during such austenitization.

### BACKGROUND OF THE INVENTION

It is standard when locally austenitizing a workpiece to cover part of the workpiece, for instance a steel plate, with a shield and then heating the partially shielded workpiece in a tempering furnace. The shield covers a predetermined portion of the plate workpiece, for instance an outer edge, and prevents it from being austenitized.

More particularly, in the prior art the shield is introduced into a furnace together with a plate workpiece for heating to approximately the austenitization temperature. In this case, the plate workpiece is partly covered by the shield, so that this covered area is shielded from the heat application and is not further heated. The covered area slowly cools in the furnace to a temperature below the austenitizing temperature and above the martensite start temperature. The uncovered area of the workpiece continues to be heated or kept at the austenitizing temperature. After a predetermined dwell time in the furnace, the workpiece has areas with different temperatures, and is then removed from the furnace after a predetermined dwell time and shaped into a shaped part in a forming tool and hardened. Due to the different temperatures in the material, areas with different strengths are set during the subsequent forming and abrupt cooling.

In order for these areas to be accurately located in the tolerance ranges provided for them, the geometry of the shield has to be adapted to the areas to be shielded in a complex manner, so that the areas that are later to be more ductile can be covered exactly.

When manufacturing a shield adapted to a workpiece, a shield is first manufactured with an oversize, i.e. the shape or geometry of the shield is only approximate to the final shape. The edges are then reworked, i.e. removed and checked, until the shield has an optimal shape that enables shielding of the intended areas. In order to check the shape of the shield and to determine the areas in which postprocessing of the edges is still necessary, a plate workpiece together with the shield is placed in a furnace and heat is applied. The plate is then formed and hardened, and the location and shape of the areas of different strength are checked. If the areas are not within the specified tolerance ranges, the edges of the shield are reworked in the corresponding regions. To do this, the entire shield must be removed from the furnace, clamped in place for processing and reworked. Processing inside the furnace is not possible. This is followed by a new check and, if necessary, a new postprocessing in the manner described until the plate workpiece meets specifications. The postprocessing and checking in several passes are very time-consuming and expensive.

If too much material is removed during postprocessing of the edges, a new shield must be manufactured because the missing material cannot be filled up again. The production of a shield with an optimal geometry is therefore very time-consuming and costly.

A further disadvantage is that an individually adapted shield has to be manufactured for each workpiece of a new shape and/or other areas of different strength.

### OBJECTS OF THE INVENTION

It is therefore an object of the present invention to provide an improved shield for local austenitization.

Another object is the provision of such an improved shield for local austenitization that overcomes the above-given disadvantages.

### SUMMARY OF THE INVENTION

A shield covers a predetermined region of a plate workpiece during tempering of the plate workpiece in a furnace in which the shield and the workpiece are subjected to an austenitization temperature while the predetermined region of the plate is shielded by the shield against heat. The shield has according to the invention at least one first shield part shaped to cover at least some of the predetermined region of the workpiece, at least one second shield part, and means securing the second part movable relative to or removable from the first part such that the first and second parts together achieve an optimum shape fully covering and shielding the predetermined region of the plate workpiece.

The shield of this invention thus has at least one first shield part, but preferably, two first shield parts arranged opposite one another are provided with second or third shield parts attached thereto, between which the plate workpiece is sandwiched during further heating in the furnace in order to cover the plate workpiece evenly on both sides.

At least one second shield part is attached to each first shield part in a detachable and/or adjustable manner in order to achieve the optimum shape. A third shield part can also be detachably and/or adjustably fastened to the first shield part. The second and/or third shield part forms part of the first shield part and can be fastened, for example, to an outer edge of the first shield part. If the second and/or third shield part is set in a desired position or attached to the first shield part, the predetermined regions of the plate workpiece are optimally covered. The shield must be checked to determine and set the target position. The attachment of the second and/or additional shield part to the first shield part and the shape of the shield parts are checked. The check is not based on the shield itself, but rather, as described in the prior art, on the basis of a molded part that is formed from a plate workpiece that was covered with the shield when heat was applied. If the check establishes that the areas of different strengths are not in the right places, the shapes can be reworked accordingly and/or the second and/or third shield part can be replaced and/or adjusted. So that the second and/or third shield part can be reworked, exchanged or adjusted in a simple manner and particularly inexpensively, it is attached to the first shield part in a detachable and/or adjustable manner.

Detachable fastening enables a second or third shield part to be replaced by a more suitable second or third shield part or else a cost-effective and particularly simple postprocessing of the second or third shield part.

For postprocessing, the second or third shield part can be detached from the first shield part and processed as a separate part, which makes handling considerably easier since the entire shield no longer has to be removed from the furnace and transported and clamped for processing. The postprocessed second or third shield part is fastened to the first shield part in the desired position after it has been processed. If the second or third shield part is also adjustable, the desired position can be set and/or optimized in the furnace, for example.

If too much material is inadvertently removed during postprocessing of the edge, the second or additional shield part can be replaced by a second or additional replacement shield part. It is no longer necessary to replace the entire shield, which means that costs arising from such faulty processing can be significantly reduced.

If the second or third shield part is fastened adjustably relative to the first shield part, it is possible to set or optimize the target position by adjusting the second or third shield part on the first shield part without having to take off the second or third shield part. The second or third shield part is preferably adjusted relative to the first shield part. The adjustability of the second or third shield part is a particular advantage since the shield no longer has to be removed from the furnace to set the desired position of the second or third shield part, but can also be adjusted inside the furnace.

The combination of a detachable and adjustable fastening enables replacement or reworking and subsequent optimization of the position to the target position when the second or third shield part is fastened to the first shield part. This can be advantageous, for example, if there are still small deviations from the optimal target shape during a further check of the shield and the position of the shield parts has to be optimized.

The adjustability can be useful and can be used for a shield part of any size or shape. The adjustment for a second or third shield part is preferably used if the shield part has an outer edge whose shape to a grid. This means, for example, a straight edge without irregularities, which for example runs parallel to a likewise straight edge region of the plate workpiece to be shielded.

On the other hand, postprocessing preferably takes place when the edge to be adjusted or an edge region has a contour that is not bound to a grid, i.e. the contour is an irregularly running contour, such as a wave.

A plurality of second and/or third shield parts can be fastened to the first shield part and be detachably and/or adjustably fastened to the respective first shield part in accordance with the second or third shield part. The discussion above regarding the second and additional shield part apply accordingly to each additional shield part.

A major advantage of the shield is that it can be easily and quickly adapted to a workpiece to be shielded.

Another advantage is that the shield can be used flexibly. It is possible, for example, to produce a first shield part that can be used in a variety of ways and is suitable as the basis for a large number of products. At least one second or additional shield part is attached to the first shield part, which can be adapted or matched to the corresponding workpiece to be shielded so projects can be customized. In this way, a particularly cost-effective shield can be provided for a large number of products, without the entire shield having to be manufactured from scratch in each case.

Provision is preferably made for the second and/or third shield part to be adjustable or adjusted relative to the first shield part in order to achieve the optimal shape.

According to the invention the second and/or third shield part is part of the first shield part and is movably attached to the first shield part in order to optimize the shape. The plate workpiece is fixed in the furnace independently of the shield and is not moved when the second or third shield part is adjusted.

Provision is preferably made for the second shield part and/or the third shield part to be adjusted outside or inside the furnace. It is however particularly advantageous to adjust the second and/or third shield part on the first shield part inside the furnace, since then there is no need for a complex removal of the shield from the furnace.

In accordance with the invention the second shield part and/or the third shield part is adjustably fastened to the first shield part by a spindle drive. Such a spindle drive offers an inexpensive and simple solution for attaching the second or third shield part to the first shield part and adjusting it relative to it. Adjustment of the shield takes place manually, preferably by actuating a handle or a hand wheel coupled to or on the spindle.

Alternatively, it is particularly preferred that the adjustment takes place by means of an electric servomotor. This makes it possible, in particular, to set and optimize the target position of the second or third shield part within the furnace.

It is preferably provided that the shield consists of two first shield parts arranged opposite one another with second and/or third shield parts fastened detachably and/or adjustably to them, between which the plate workpiece is supported in the furnace and shielded on both sides, it being particularly preferably provided that the first shield parts and the second and/or third shield parts fastened thereto are designed and adjusted congruently to one another.

A first shield part above the workpiece and another first shield part below the workpiece are provided, with a second and/or additional shield part on the top being attached to the upper first shield part and a second or additional shield part on the underside being attached to the lower first shield part. The plate workpiece is arranged between the upper and lower first shield parts. The intended areas of the plate workpiece are then shielded from both sides of the plate workpiece, which is equally covered and shielded from both sides.

Provision is also preferably made for the parts of the plate workpiece to be shielded without contact by the shield. Thus the plate workpiece is not touched by the shield during shielding.

In addition, it is preferably provided that the second shield part and/or the third shield part is fastened to an outer edge of the first shield part or a section of the shield part, and that the respective outer edge of the first shield part juxtaposed over at least part of the length of the second and/or third shield part has a first lip facing the second and/or third shield part and projecting therefrom, and the second and/or third shield part has a second and/or further lip facing the corresponding edge and projecting toward it, at least partially covering the first lip, and the shield forms a gap with a gap opening between the edge of the first shield part and the second and/or third shield part in the desired position of the second and/or third shield part, which gap runs transversely to a plane spanned by the plate workpiece, the gap opening is at least partially blocked, at least to radiant heat energy, by the first lip and/or the second or further lip.

In order to prevent heat from being introduced into the region of the plate workpiece located under the gap opening, the gap opening is at least partially covered by the first lip and/or the second or further lip. The lips preferably at least partially overlap in the gap opening. It is preferably provided that the first lip is a first strip and the second or further lip is a second or further strip extending parallel to the plate workpiece surface. Such strips can be attached to the shield in a simple manner as a lip.

According to the method of this invention a workpiece is heated to austenitization temperature,

the workpiece is held in a furnace at about the austenitization temperature while predetermined regions of the plate are shielded by a shield and cool to a temperature below the austenitization temperature and above the martensite start temperature. Then the plate workpiece is removed from the furnace after a dwell time, placed in a forming tool and formed into a molded part and cooled therein, the molded part having high-strength areas and having a lower strength in the previously shielded sub-areas.

According to the invention the shield is in several parts and consists of at least one first shield part and at least one second and/or third shield part that supplements the first shield part to form the complete shield part, which is detached from and/or adjusted on the first shield part to achieve an optimal shape, until the second and/or third shield part covers the predetermined area of the plate workpiece in a desired position. The second and/or third shield part can be adjusted relative to the first shield part, so that the shielding area is enlarged or reduced.

In addition, it is particularly preferably provided that the target shape is achieved after the shield has been checked, with the areas of different strength being checked after the plate workpiece has been formed into a molded part, and the second or third shield part if the checked areas deviate from Target areas to achieve the target shape is exchanged, processed or adjusted to the target position. These method steps to be repeated until the checked areas match the target areas. Finally the set position is set outside or inside the furnace.

### BRIEF DESCRIPTION OF THE DRAWING

The above and other objects, features, and advantages will become more readily apparent from the following description, reference being made to the accompanying drawing in which:

FIG. 1 shows a shield frame according to the invention;

FIG. 2 shows the shield frame without the workpiece;

FIG. 3 shows the shield frame with the workpiece; and

FIGS. 4 and 5 are section taken along respective lines IV-IV and V-V of FIG. 3.

### SPECIFIC DESCRIPTION OF THE INVENTION

As seen in the drawing, a shield 1 serves for covering at least part of a plate workpiece 2 while the plate workpiece 2 is being tempered in a furnace. This shield 1 and the plate workpiece 2 are heated to approximately the austenitization temperature in the furnace while a part of the plate workpiece 2 is covered by the shield 1 to reduce its heating and prevent it from reaching the austenitization temperature. The furnace is not shown in the figures. The four arrows 18 in each of FIGS. 4 and 5 represent the thermal radiation in the furnace. Thus the unshielded area of the plate workpiece 2 is kept or heated to the austenitization temperature by thermal radiation in the furnace.

The shield 1 comprises two first shield parts 3, 3′, two second shield parts 4, 4′, and two third shield parts 5, 5′, all movable relative to each other. The second shield parts 4, 4′ and the third shield parts 5, 5′ are detachably mounted on inner edges 6, 6′ of the first shield parts 3, 3′. The third shield parts 5, 5′ are attached to opposite inner edges 7, 7′ in a detachable and adjustable manner. The second and the third shield parts 4, 4′ and 5, 5′ can be detached in order to achieve an optimal shape, and the third shield parts 5, 5′ are additionally fastened adjustably to the respective first shield parts 3, 3′. In the illustrated position of the second shield parts 4, 4′ and the third shield parts 5, 5′, the predetermined region of the plate workpiece 2 is covered. The parts of the plate workpiece 2 are shielded by the shield 1 in a without direct contact.

The first shield part 3 with the second shield part 4 attached thereto and the third shield part 5 sit atop the first shield part 3′ with the second shield part 4′ attached thereto and the third shield part 5′. The shield parts 3, 3′ and the second and third shield parts 4, 4′ and 5, 5′ are constructed and adjusted congruently to one another. The plate workpiece 2 is held in the furnace sandwiched between the frame-like subassembly of the shield parts 3, 4, 5 on its upper face and the identical frame-like subassembly of the shield parts 3′, 4′, and 5′ on its lower face and thus is evenly shielded on both faces.

If the second and the third shield parts 4, 4′, 5, 5′ are set in a desired position or attached to the respective first shield part 3, 3′, the predetermined regions of the plate workpiece 2 are optimally covered. A check of the shield 1 is necessary to determine and set the target position. The attachment of the second and third shield parts 4, 4′, 5, 5′ to the first shield part 3, 3′, as well as the shape of the second and third shield parts 4, 4′, 5, 5′ are checked. The check is not based on the shield 1 itself, but rather, as described in the prior art, on the basis of a molded part that is formed and hardened from a plate workpiece 2 that was covered with the shield 1 when austenitizing heat was applied. If the check establishes that the areas of different strength are not in the predetermined areas, the shield 1 must be revised. During revision, the second and third shield parts 4, 4, 5, 5 are to be processed and/or adjusted in such a way that the desired shielding of the intended areas can take place.

For this purpose, the second shield parts 4, 4′ are detachably fastened to the respective first shield parts 3, 3′. The detachability allows replacement of the second shield parts 4, 4′ by more suitable and differently shaped and/or constituted second shield parts or an inexpensive and particularly simple postprocessing of the second shield part 4, 4′.

For postprocessing, the second shield parts 4, 4′ can be detached from the first shield parts 3, 3′ and processed as separate parts, which makes handling considerably easier since the entire shield 1 is no longer removed from the furnace and transported and processed. During postprocessing, material is removed from an edge 11 of the shield part 4, 4′. The postprocessed second shield part 4, 4′ is fastened to the respective first shield part 3, 3′ in the desired position after it has been processed. FIGS. 1, 2, 3 and 5 show the second shield parts 4, 4′ in a preassembly position, in which there are still gaps 12 between the second shield part 4, 4′ and the first shield part. A sectional view is shown in FIG. 5 and shows, among other things, fasteners 17, 17′ that secure the respective second shield parts 4, 4′ to the first shield parts 3, 3′. The fasteners 17, 17′ pass through the gap 12 at this point. In the target position, the second shield parts 4, 4′ abut flatly against the inner edges 6, 6′ of the first shield parts 3, 3′, without gap being formed.

If too much material is inadvertently removed during postprocessing of the edge region 11, the second shield part 4, 4′ can for example be exchanged for another replacement shield part. It is no longer necessary to replace the entire shield 1, which means that the costs arising from such faulty processing can be significantly reduced.

The third shield parts 5, 5′ are detachably and adjustably attached to the respective first shield parts 3, 3′. This makes it possible to replace or rework the third shield parts 5, 5′ in the manner described with reference to the second shield parts 4, 4′. It is also possible to set or optimize the desired position by adjusting the third shield parts 5, 5′ on the first shield parts 3, 3′, without the third shield part 5, 5′ having to be detached from the first shield part 3, 3′. The third shield parts 5, 5′ are adjusted relative to the first shield parts 3, 3′. The adjustability of the third shield part 5, 5′ is a particular advantage since the shield 1 no longer has to be removed from the furnace to set the target position of the third shield part 5, 5′, and an adjustment can also be made inside the furnace.

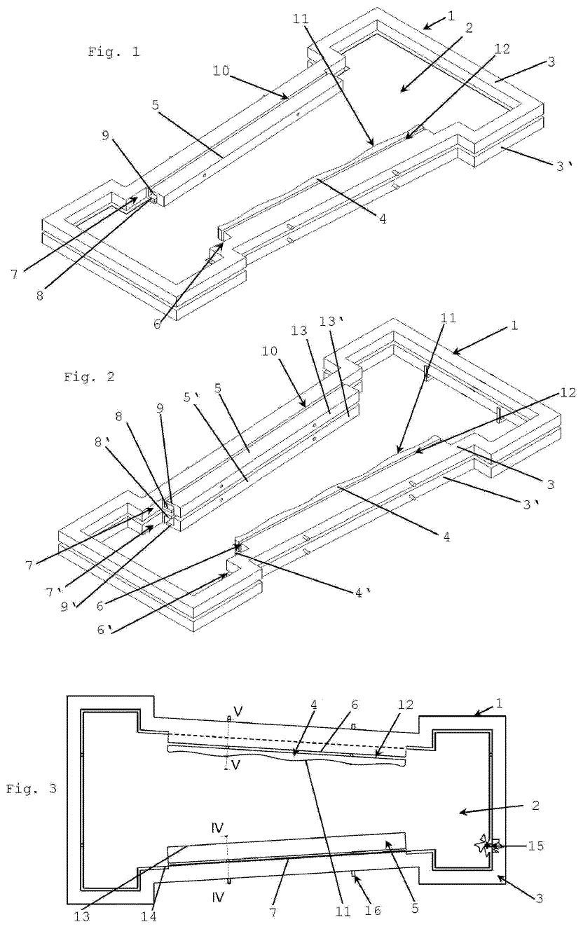

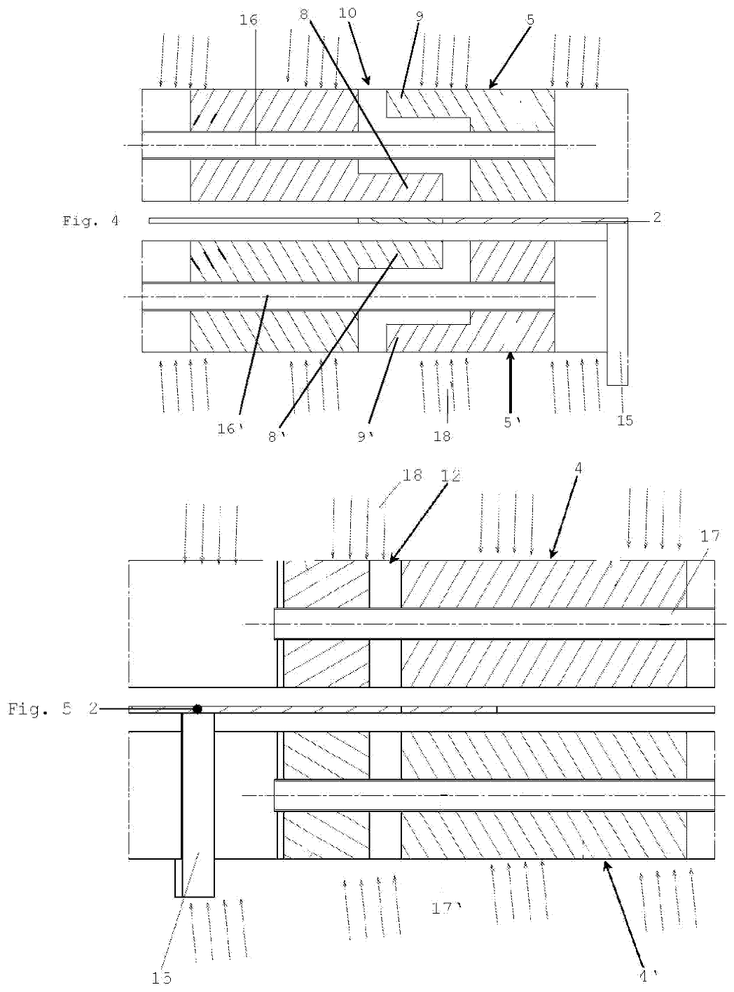

The adjustability can be useful with any form of shield part. In the illustrated embodiment, the adjustment is used for third shield parts 5, 5′ having respective edges 13, 13′ which has a shape based on a rectilinear grid, namely straight edges without irregularities that run parallel to likewise straight edges 14, 14′ of the plate workpiece to be shielded, which is shown in FIG. 3.

In the case of the second shield parts 4, 4′, a detachable connection to the first shield parts 3, 3′ with the possibility of postprocessing of the second shield part 4, 4′ is preferred in this embodiment, since the edge regions 11 of the second shield parts 4, 4′ have a corrugated shape which is not a straight line, but is an irregularly extending contour, such as a wave, as shown in FIGS. 1, 2 and 3. In this illustrated embodiment, an adjustment would not lead to the desired result if, for example, the corrugations were not sharp enough. Postprocessing can therefore be useful for this second shield part 4, 4′. Additional adjustability is not excluded.

The plate workpiece 2 is fixed in the furnace independently of the shield 1, for example sitting on supports 15 in the furnace, and is not moved when the second or third shield parts 4, 4′, 5, 5′ are adjusted.

The third shield part 5, 5′ can be adjusted outside or inside the furnace, with an adjustment inside the furnace being particularly advantageous since there is then no need for a complex removal of the shield 1 from the furnace. For adjustment, the third shield part 5, 5′ is adjustably fastened to the first shield part 3, 3′ by spindles 16, 16′ shown in FIG. 4. The spindles 16, 16′ form an inexpensive and simple solution for attaching the third shield parts 5, 5′ to the respective first shield parts 3, 3′ and adjusting them relative to it. Adjustment is made with an electric servomotor, for example.

As shown in FIGS. 1 and 2, the outer edges 7, 7′ of the first shield part 3, 3′ have, over the length of the third shield parts 5, 5′ attached thereto, first lips 8, 8′ facing the third shield part 5, 5′ and projecting away from the respective edge 7, 7′. The third shield parts 5, 5′ also has further lips 9, 9′ facing and projecting toward the edges 7, 7′. The first lips 8, 8′ and the further lips 9, 9′ overlap at least partially parallel to a plane of the shield 1. The shield 1 thus is formed between the edges 7, 7 ‘of the first shield parts 3, 3’ and the third shield parts 5, 5′ in the target position of the third shield part 5, 5′ with a Z-shaped gap 10 extending transversely to a plane of the shield 1 with the gaps of the first lips 8, 8′ and the further lips 9, 9′ being at least partially offset so radiant heat cannot pass through the shield 1. This is shown in the sectional view in FIG. 4. As a result, heat is prevented from entering the plate 2 lying under the gap 10. The first lip 8, 8′ is a first strip and the further lip 9, 9′ is designed as a further strip. Such strips can be attached to the shield 1 in a simple manner to form the lips 8, 8′ and 9, 9′.

The shield 1 can be precisely and quickly adapted to a workpiece to be shielded in a simple manner. In addition, flexible use of the shield 1 is possible, since it is possible to use the first shield parts 3, 3′ as the basis for a large number of similar workpiece and only the second and/or third shield parts 4, 4′, 5, 5′ need be exchanged or attached to the first shield parts 3, 3′ in order to adjust the shield 1 to another workpiece. As a result, a completely new shield 1 no longer has to be produced for each new workpiece.

In this way, a particularly cost-effective shield 1 can be provided for a large number of workpiece.

The invention is not limited to the illustrated embodiment, but is variable in many ways within the scope of the disclosure.

All individual and combination features disclosed in the description and/or drawing are regarded as essential to the invention.

We claim:

1. A shield for covering a predetermined region of a plate workpiece during tempering of the plate workpiece in a furnace in which the shield and the workpiece are subjected to an austenitization temperature while the predetermined region of the plate is shielded by the shield against heat, the shield comprising:
at least one first shield part shaped to cover at least some of the predetermined region of the workpiece;
at least one second shield part; and
means securing the second part movable relative to or removable from the first part such that the first and second parts together achieve an optimum shape fully covering and shielding the predetermined region of the plate workpiece.

2. The shield according to claim 1, wherein the second shield part and/or a third shield part can be adjusted or aligned on the first part.

3. The shield according to claim 1, wherein the means is a spindle engaged operatively between the first and second shield parts.

4. The shield according to claim 3, wherein the spindle is provided with a handle or hand wheel for rotation.

5. The shield according to claim 3, wherein the means includes an electric servomotor connected to the spindle.

5. The shield according to claim 1, wherein there are two such first parts between which the workpiece is sandwiched and two respective second parts.

6. The shield according to claim 5, wherein the first parts are congruent to each other and the second parts are also congruent to each other.

7. The shield according to claim 1, wherein the shield lies in a plane and the first parts has an outer edge turned toward an outer edge of the second part, the outer edge of the first part having a lip extending parallel to the plane toward the second part, the outer edge of the second part having a respective lip projecting parallel to the plane the outer edge of the first part, the lips overlapping such that radiant energy transverse to the plane is blocked from going through the shield where the lips overlap, the means serving to adjust a position of the second part relative to the first part by movement parallel to the plane.

8. The shield according to claim 7, wherein the lips are formed by strip secured to the respective parts.

9. The shield according to claim 7, wherein the lips are unitary with the respective parts.

10. A method of locally tempering a plate workpiece comprising the steps of:
providing a first part and a second part that together form a shield for a predetermined region of a plate workpiece;
adjusting the relative positions of the first and second part or a size or shape of the second part such that the first and second parts only covers a predetermined region of the workpiece;
covering the predetermined region of the workpiece with the shield while leaving the rest of the workpiece exposed;
heating the workpiece with the shield covering the predetermined region in a furnace such that the workpiece is only heated to the austenitizing temperature where it is not covered by the shield; and
subsequently cooling the workpiece such that it has high-strength areas and areas corresponding to the predetermined region of a lower strength.

11. The method of claim 10, wherein the relative positions of the first and second part are adjusted inside the furnace.

12. The method of claim 10, wherein the plate workpiece has a pair of opposite faces that are each juxtaposed in the furnace by a respective such shield formed of first and second parts.

13. The method of claim 10, further comprising the steps of:
checking the cooled workpiece and, if the areas of different strength do not comply with a predetermined desired position or size, adjusting the position of the second part inside the furnace.
